(19) United States
(12) Patent Application Publication
(10) Pub. No.: US 2024/0192095 A1
(43) Pub. Date: Jun. 13, 2024

(54) STATE DETECTION SYSTEM, STATE DETECTION METHOD, AND COMPUTER READABLE MEDIUM

(71) Applicant: Mitsubishi Electric Corporation, Tokyo (JP)

(72) Inventor: Daiki NAKAHARA, Tokyo (JP)

(73) Assignee: Mitsubishi Electric Corporation, Tokyo (JP)

(21) Appl. No.: 18/585,794

(22) Filed: Feb. 23, 2024

Related U.S. Application Data
(63) Continuation of application No. PCT/JP2021/038283, filed on Oct. 15, 2021.

(51) Int. Cl. G01M 99/00

(52) U.S. Cl. CPC G01M 99/005

(57) ABSTRACT

A collection unit (111) collects collected data of a plurality of signals in a facility in chronological order. A division unit (112) divides the collected data in chronological order into a plurality of groups so as to generate collected divided data for each group. A learning unit (113) performs machine learning for each group, using the collected divided data as learning data, so as to generate a normal model, which is a learned model, for each group. A state detection unit detects a state of the facility, using the normal model of each group.

### CROSS REFERENCE TO RELATED APPLICATIONS

This application is a Continuation of PCT International Application No. PCT/JP2021/038283 filed on Oct. 15, 2021, which is hereby expressly incorporated by reference into the present application.

### TECHNICAL FIELD

The present disclosure relates to a technology to detect an anomaly in a facility.

### BACKGROUND ART

It is desired to detect an anomaly in a production facility.

Patent Literature 1 discloses a technology aimed at detecting an anomaly in a production facility.

In this technology, operation data composed of a plurality of bit signals is collected first when the operation status of the facility is a steady state. Next, a normal model for determining the operation status of the facility is generated. Next, an expected value of the operation data of the facility and an actual measurement value of the operation data are compared using the normal model. Then, it is detected whether the operation status of the facility is an unsteady state.

### CITATION LIST

### Patent Literature

Patent Literature 1: JP 6678824 B

### SUMMARY OF INVENTION

### Technical Problem

A problem of the technology of Patent Literature 1 is that if the scale of the production facility increases and the number of signals increases, the relationships between signals become complex, increasing a required learning time and a required amount of learning data.

In a production facility of a factory, a plurality of workpieces are often processed in parallel. If a plurality of workpieces are processed in parallel and each process is not synchronized, the processing timing of each workpiece may differ each time due to the impact of a shift in the input timing of each workpiece, for example.

Therefore, in a case where the behavior of the entire facility is learned using one learned model, if the processing timings of a plurality of workpieces are to be covered, the required learning time and the required amount of learning data will increase.

An object of the present disclosure is to make it possible to generate a learned model for detecting a state of a facility with a short learning time and a small amount of learning data.

### Solution to Problem

A state detection system according to the present disclosure is a system to detect a state of a facility in which a workpiece is moved in a flow.

The state detection system includes
a collection unit to collect, in chronological order, collected data that indicates a plurality of signal values of a plurality of signals that react in sequence according to the flow of the workpiece;
a division unit to divide a set of the plurality of signal values included in the collected data in chronological order into a plurality of groups so as to generate, for each group, collected divided data that indicates one or more signal values in each group in chronological order;
a learning unit to perform machine learning for each group, using the collected divided data as learning data, so as to generate a normal model, which is a learned model, for each group; and
a state detection unit to detect a state of the facility, using the normal model of each group.

### Advantageous Effects of Invention

According to the present disclosure, a learned model for detecting a state of a facility can be generated with a short learning time and a small amount of learning data.

### BRIEF DESCRIPTION OF DRAWINGS

FIG. 1 is a configuration diagram of a facility system 200 in Embodiment 1;

FIG. 2 is a configuration diagram of a state detection system 100 in Embodiment 1;

FIG. 3 is a configuration diagram of a model generation unit 110 and a state detection unit 120 in Embodiment 1;

FIG. 4 is a functional relationship diagram of the model generation unit 110 in Embodiment 1;

FIG. 5 is a functional relationship diagram of the state detection unit 120 in Embodiment 1;

FIG. 6 is a flowchart of a state detection method in Embodiment 1;

FIG. 7 is a flowchart of a model generation process (S110) in Embodiment 1;

FIG. 8 is a figure illustrating an example of a production facility 240 in Embodiment 1;

FIG. 9 is a figure illustrating an example of grouping in the production facility 240 in Embodiment 1;

FIG. 10 is a flowchart of a state detection process (S120) in Embodiment 1;

FIG. 11 is a figure illustrating an example of variables of normal models 301 in Embodiment 2;

FIG. 12 is a configuration diagram of the state detection system 100 in Embodiment 3;

FIG. 13 is a functional relationship diagram of the model generation unit 110 in Embodiment 3;

FIG. 14 is a flowchart of the model generation process (S110) in Embodiment 3;

FIG. 15 is a figure illustrating grouping of signals in Embodiment 3;

FIG. 16 is a flowchart of the model generation process (S110) in Embodiment 4;

FIG. 17 is a flowchart of the model generation process (S110) in Embodiment 5;

FIG. 18 is a configuration diagram of the state detection system 100 in Embodiment 6;

FIG. 19 is a functional relationship diagram of the state detection unit 120 in Embodiment6;

FIG. 20 is a flowchart of a re-learning method in Embodiment 6; and

FIG. 21 is a hardware configuration diagram of the state detection system 100 in the embodiments.

### DESCRIPTION OF EMBODIMENTS

In the embodiments and drawings, the same elements or corresponding elements are denoted by the same reference sign. Description of an element denoted by the same reference sign as that of an element that has been described will be suitably omitted or simplified. Arrows in figures mainly indicate flows of data or flows of processing.

### Embodiment 1

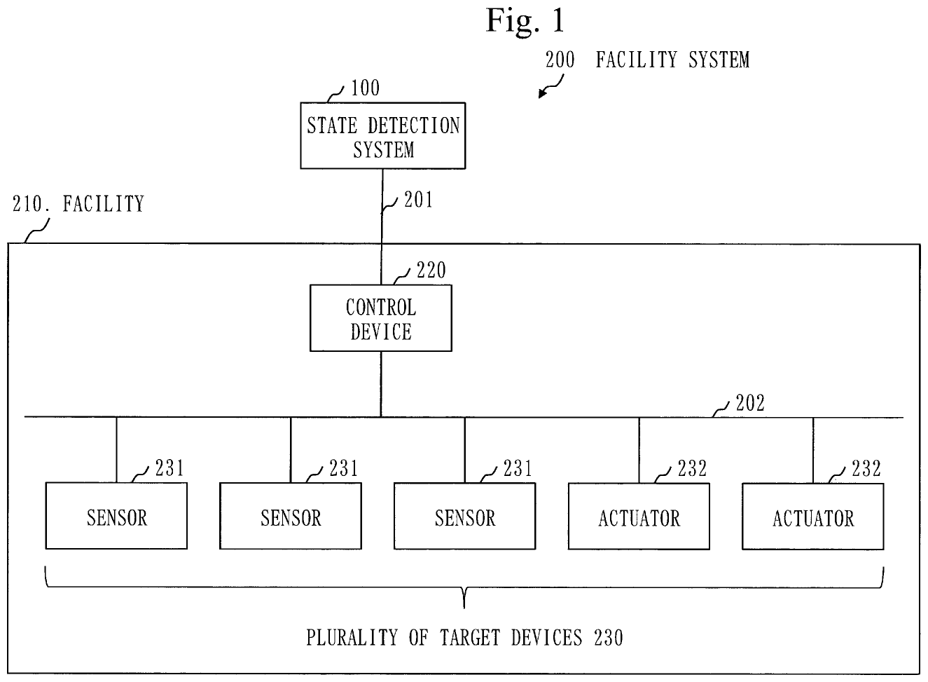

A state detection system 100 will be described based on FIGS. 1 to 10.

### Description of Configuration

Based on FIG. 1, a configuration of a facility system 200 will be described.

The facility system 200 includes a facility 210 and the state detection system 100.

The facility 210 is a facility to process or assemble workpieces. The workpieces are moved in a flow in the facility 210. The workpieces are objects to be processed or assembled.

The facility 210 includes a control device 220 and a plurality of target devices 230.

The control device 220 is a device for a factory and controls the facility 210. For example, the control device 220 is a programmable logic controller (PLC). However, the control device 220 may be a general computer.

The target devices 230 are devices to be controlled by the control device 220, and receive as input various signals and output various signals. Specific examples of the target devices 230 are sensors 231 and actuators 232.

The control device 220 and the state detection system 100 are connected with each other through a network 201.

The control device 220 and each of the target devices 230 are connected with each other through a network 202.

Each of the network 201 and the network 202 is a field network, a general network, or a dedicated input/output signal line. A specific example of the field network is a CC-Link. A specific example of the general network is Ethernet (registered trademark).

The network 201 and the network 202 may be networks of the same type, or may be networks of mutually different types.

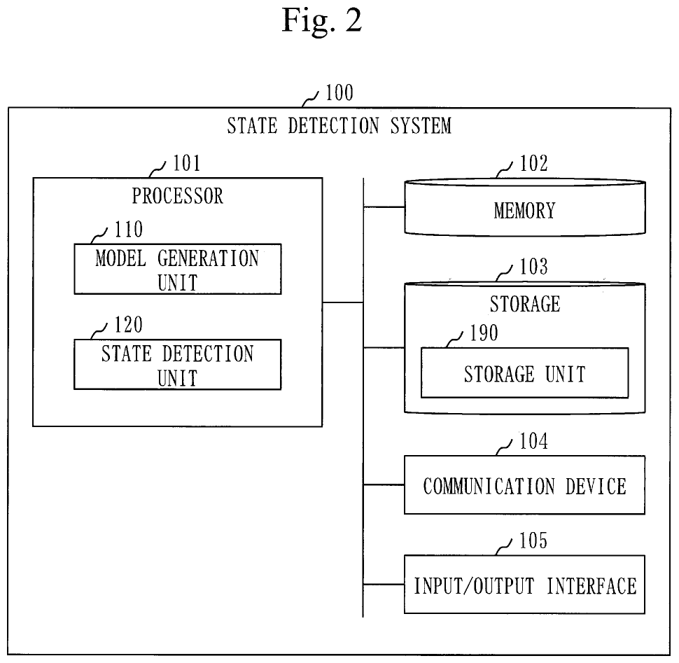

Based on FIG. 2, a configuration of the state detection system 100 will be described.

The state detection system 100 is a computer that includes hardware such as a processor 101, a memory 102, a storage 103, a communication device 104, and an input/output interface 105. These hardware components are connected with one another through signal lines.

The processor 101 is an IC that performs operational processing and controls other hardware components. For example, the processor 101 is a CPU.

IC is an abbreviation for integrated circuit.

CPU is an abbreviation for central processing unit.

The memory 102 is a volatile or non-volatile storage device. The memory 102 is also called a main storage device or a main memory. For example, the memory 102 is a RAM. Data stored in the memory 102 is saved in the storage 103 as necessary.

RAM is an abbreviation for random access memory.

The storage 103 is a non-volatile storage device. For example, the storage 103 is a ROM, an HDD, a flash memory, or a combination of these. Data stored in the storage 103 is loaded into the memory 102 as necessary.

ROM is an abbreviation for read only memory.

HDD is an abbreviation for hard disk drive.

The communication device 104 is a receiver and a transmitter. For example, the communication device 104 is a communication board, a communication chip or a NIC. Communication of the state detection system 100 is performed using the communication device 104.

NIC is an abbreviation for network interface card.

The input/output interface 105 is a port to which an input device and an output device are connected. For example, the input/output interface 105 is a USB terminal. An example of an input device is a keyboard and a mouse. An example of an output device is a display. An example of an input/output device is a touch panel. Input to and output from the state detection system 100 are performed using the input/output interface 105.

USB is an abbreviation for Universal Serial Bus.

The state detection system 100 includes elements such as a model generation unit 110 and a state detection unit 120. These elements are realized by software.

The storage 103 stores a state detection program to cause a computer to function as the model generation unit 110 and the state detection unit 120. The state detection program is loaded into the memory 102 and executed by the processor 101.

The storage 103 further stores an OS. At least part of the OS is loaded into the memory 102 and executed by the processor 101.

The processor 101 executes the state detection program while executing the OS.

OS is an abbreviation for operating system.

Input data and output data of the state detection program are stored in a storage unit 190.

The storage 103 functions as the storage unit 190. However, a storage device such as the memory 102, a register in the processor 101, and a cache memory in the processor 101 may function as the storage unit 190 in place of the storage 103 or together with the storage 103.

The state detection system 100 may include a plurality of processors as an alternative to the processor 101.

The state detection program can be recorded (stored) in a computer readable format in a non-volatile recording medium such as an optical disc or a flash memory.

The state detection system 100 may be composed of a plurality of computers.

For example, the state detection system 100 may be composed of a computer that functions as the model generation unit 110 and a computer that functions as the state detection unit 120.

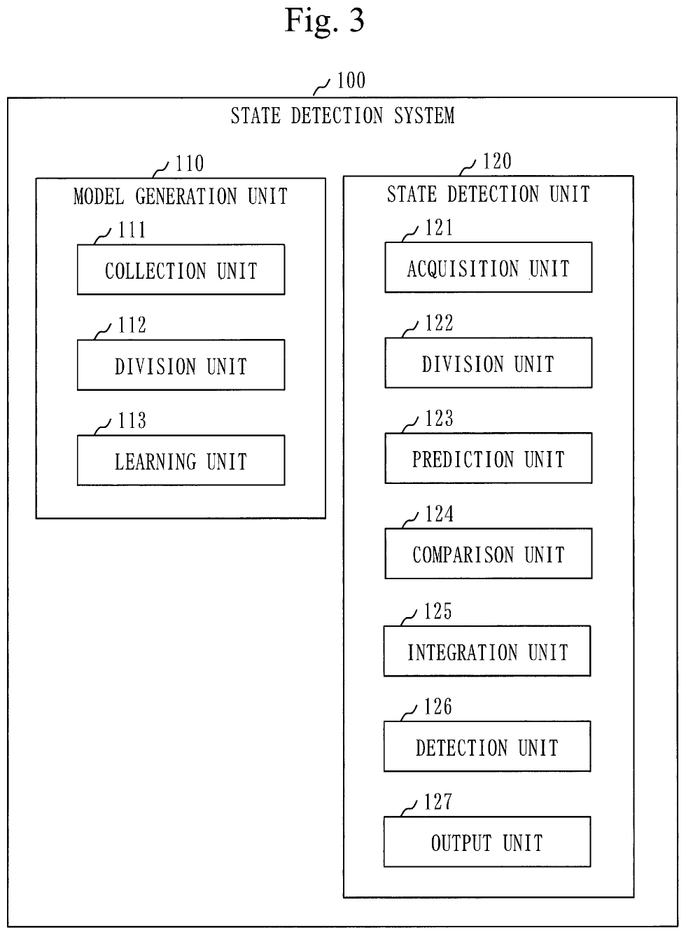

Based on FIG. 3, a configuration of each of the model generation unit 110 and the state detection unit 120 will be described.

The model generation unit 110 includes elements such as a collection unit 111, a division unit 112, and a learning unit 113.

The state detection unit 120 includes elements such as an acquisition unit 121, a division unit 122, a prediction unit 123, a comparison unit 124, an integration unit 125, a detection unit 126, and an output unit 127.

The functions of these elements will be described later.

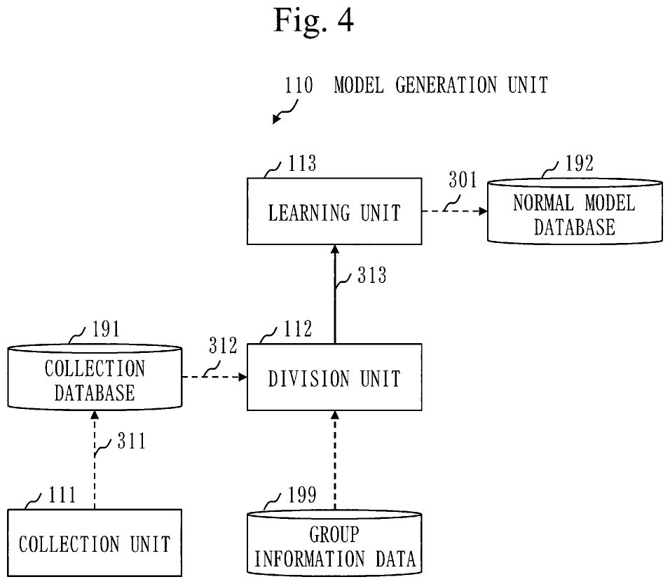

FIG. 4 illustrates functional relationships of the model generation unit 110.

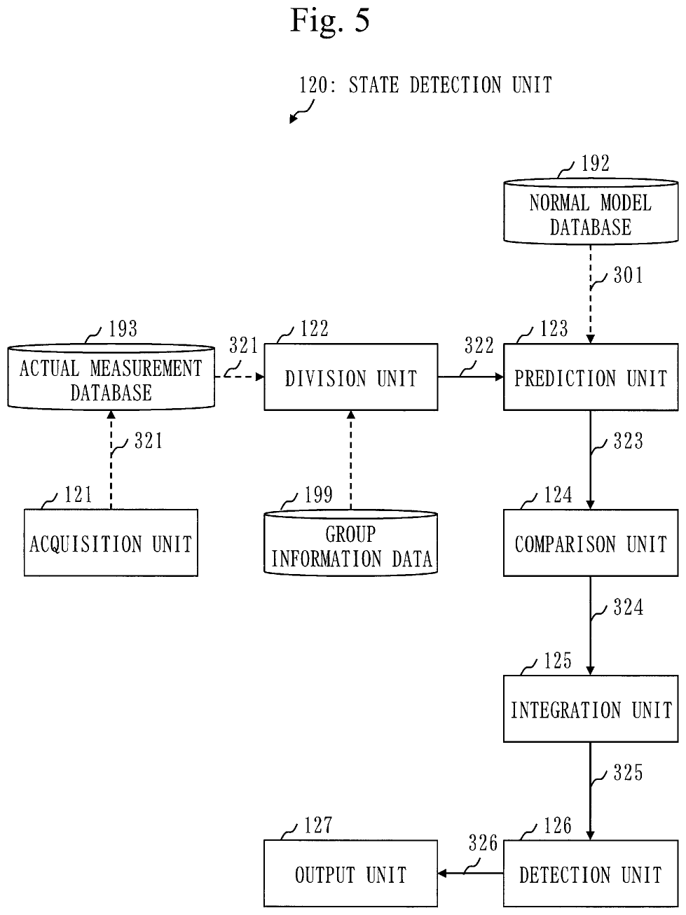

FIG. 5 illustrates functional relationships of the state detection unit 120.

A collection database 191, a normal model database 192, an actual measurement database 193, and group information data 199 are stored in the storage unit 190.

The details of these pieces of data will be described later.

### Description of Operation

A procedure for operation of the state detection system 100 is equivalent to a state detection method. The procedure for operation of the state detection system 100 is also equivalent to a procedure for processing by the state detection program.

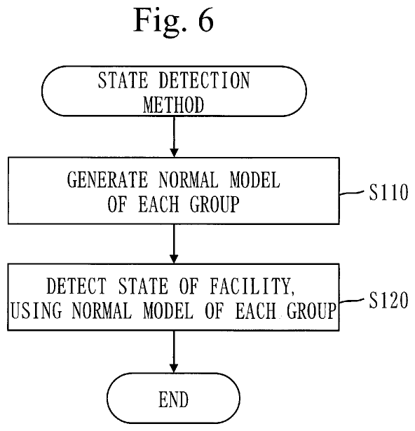

Based on FIG. 6, the state detection method will be described.

In step S110, the model generation unit 110 generates a normal model 301 of each group.

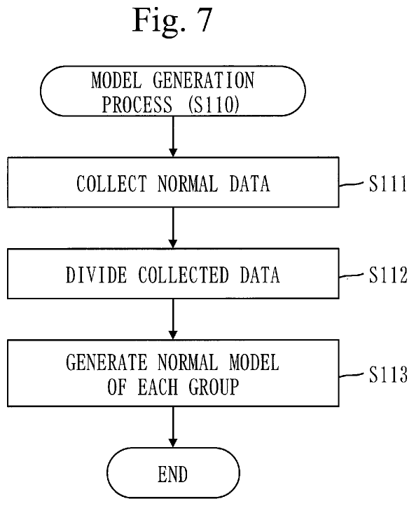

Based on FIG. 7, a procedure for a model generation process (S110) will be described.

In step S111, the state of the facility 210 is a normal state. “Normal” can be replaced with “steady”.

The collection unit 111 collects normal data 311 in chronological order. That is, the collection unit 111 collects the normal data 311 at each time point. Specifically, the collection unit 111 receives the normal data 311 in chronological order from the control device 220.

The normal data 311 is operation data of the facility 210 in the normal state.

The normal data 311 indicates a plurality of normal values.

The normal values are signal values of the facility 210 in the normal state.

The operation data is data that indicates an operation status of the facility 210.

The operation data indicates a plurality of signal values corresponding to a plurality of signals.

The plurality of signals react in sequence according to a flow of workpieces in the facility 210 where the workpieces are moved in a flow. A reaction of a signal is equivalent to a change in a signal value.

Each signal is identified by a signal identifier.

The plurality of signal values are collected from the plurality of the target devices 230 by the control device 220. Specifically, the control device 220 receives the plurality of signal values from the plurality of the target devices 230.

The signal values are values indicated by input and output signals of the target devices 230. For example, each signal value indicates a detection of a workpiece by the sensor 231 or a state (on or off) of the actuator 232.

Each signal value is indicated in association with a signal identifier.

The collection unit 111 stores the collected normal data 311 in chronological order in the collection database 191.

Step S111 is executed until a collection condition is satisfied. For example, step S111 is executed until the normal data 311 of a designated data amount is accumulated. Alternatively, step S111 is executed until a designated time period elapses.

By step S111, the normal data 311 of the amount necessary for generating the normal model 301 of each group is accumulated in the collection database 191.

The accumulated normal data 311 in chronological order, that is, the collected normal data 311 in chronological order will be referred to as collected data 312.

In step S112, the division unit 112 acquires the collected data 312 from the collection database 191.

Then, the division unit 112 divides a set of normal values included in the collected data 312 into a plurality of groups.

Specifically, the division unit 112 divides the set of normal values into a plurality of groups based on the group information data 199.

The group information data 199 indicates, on a per group basis, a plurality of signals divided into a plurality of groups according to a reaction sequence. The group information data 199 is stored in the storage unit 190 in advance. For example, the group information data 199 is generated by a user.

The division unit 112 selects a group to which signals corresponding to normal values belong from the plurality of groups indicated in the group information data 199, and determines the selected group as a group to which the normal values belong.

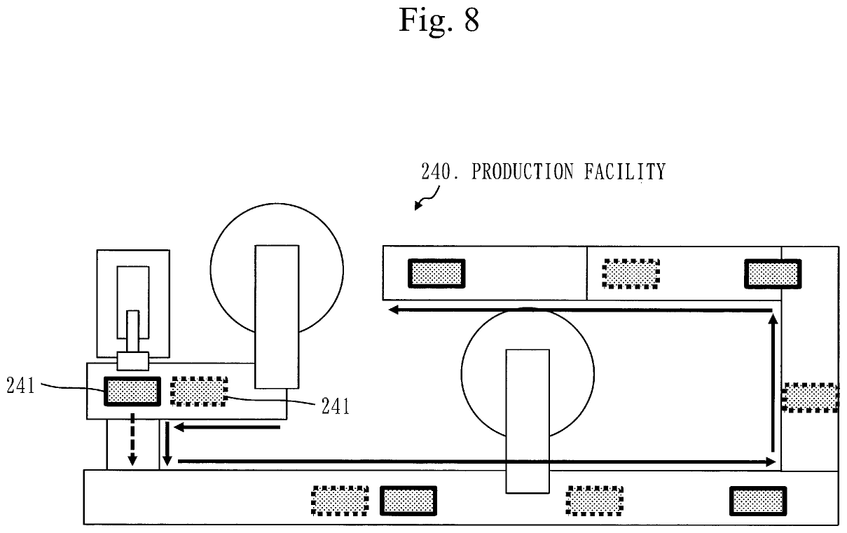

FIG. 8 illustrates a production facility 240 viewed from above. The production facility 240 is an example of the facility 210.

FIG. 8 illustrates a situation where two workpieces 241 move in a flow in the production facility 240.

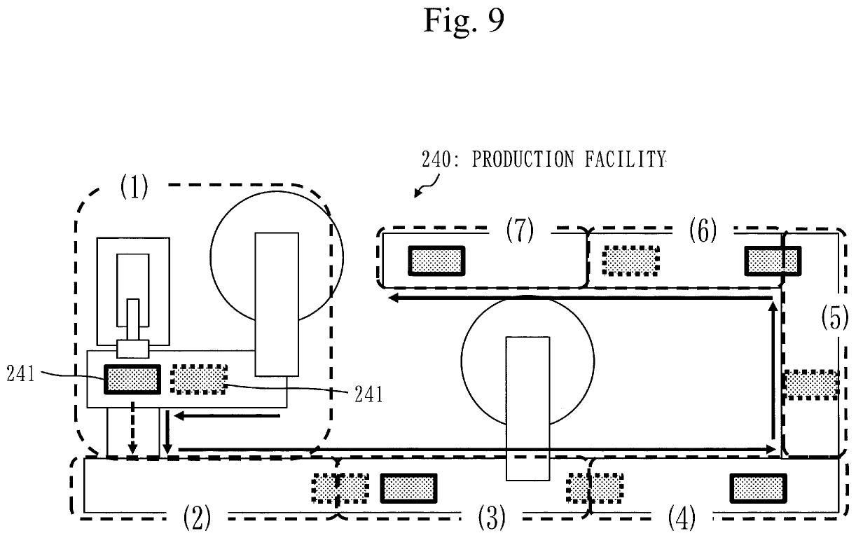

FIG. 9 illustrates the production facility 240 divided into a plurality of groups.

The production facility 240 is divided into seven groups (1) to (7) based on a sequence of the flow of the workpieces 241. A plurality of signals react in sequence according to the flow of the workpieces 241.

The group information data 199 indicates one or more signals in each of the groups (1) to (7).

Referring back to FIG. 7, the description will be continued.

The division unit 112 generates normal divided data 313 (an example of collected divided data) of each group.

The normal divided data 313 indicates one or more normal values in each group in chronological order.

In step S113, the learning unit 113 performs machine learning for each group, using the normal divided data 313 as learning data.

As a result, the learning unit 113 generates the normal model 301 of each group.

The normal model 301 is a learned model for predicting one or more signal values in each group.

Referring back to FIG. 6, step S120 will be described.

In step S120, the state detection unit 120 detects a state of the facility 210, using the normal model 301 of each group.

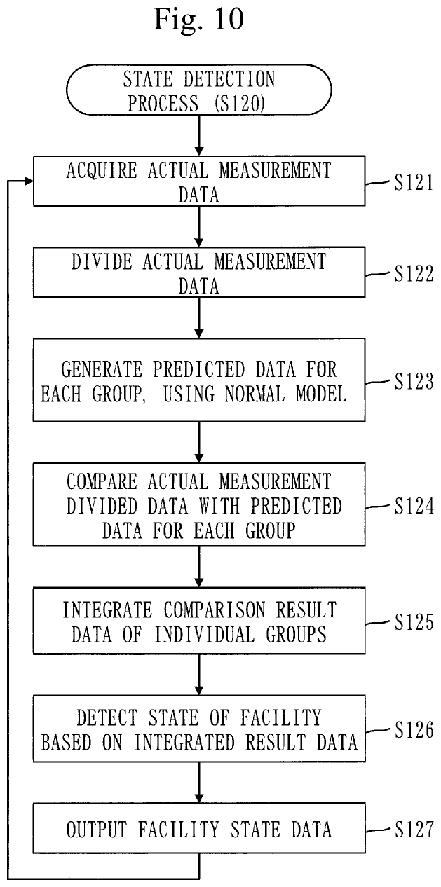

Based on FIG. 10, a procedure for a state detection process (S120) will be described.

Step S121 to step S127 are executed at each time point.

In step S121, the state of the facility 210 is a normal state or an anomalous state. “Anomalous” can be replaced with “unsteady”.

The acquisition unit 121 acquires actual measurement data 321. Specifically, the acquisition unit 121 receives the actual measurement data 321 from the control device 220.

The actual measurement data 321 is operation data of the facility 210.

The actual measurement data 321 indicates a plurality of actual measurement values.

The plurality of actual measurement values are a plurality of signal values obtained in step S121.

Then, the acquisition unit 121 stores the actual measurement data 321 in the actual measurement database 193.

In step S122, the division unit 122 acquires the actual measurement data 321 from the actual measurement database 193.

Next, the division unit 122 divides the plurality of actual measurement values in the actual measurement data 321 into a plurality of groups.

Specifically, the division unit 122 divides the plurality of actual measurement values into the plurality of groups based on the group information data 199. The method of grouping is the same as the method in step S112.

Then, the division unit 122 generates actual measurement divided data 322 of each group.

The actual measurement divided data 322 indicates one or more actual measurement values in each group.

In step S123, the prediction unit 123 generates predicted data 323 for each group, using the normal model 301.

The predicted data 323 indicates one or more predicted values in each group.

The predicted values are signal values that are predicted to be obtained next time.

Specifically, the prediction unit 123 operates as described below for each group.

First, the prediction unit 123 acquires the normal model 301 of a target group from the normal model database 192.

Then, the prediction unit 123 calculates the normal model 301, using as input the actual measurement divided data 322 of the target group at the preceding time. As a result, one or more predicted values of the target group are obtained.

A procedure for the calculation is as described below. The normal model 301 has one or more explanatory variables and one or more objective variables.

First, the prediction unit 123 sets one or more actual measurement values indicated in the actual measurement divided data 322 of the preceding time in the one or more explanatory variables.

Next, the prediction unit 123 calculates the normal model 301.

Then, the prediction unit 123 acquires one or more predicted values that are set in the one or more objective variables.

The prediction unit 123 may calculate a plurality of normal models 301 corresponding to a plurality of groups in parallel.

In step S124, the comparison unit 124 compares the actual measurement divided data 322 with the predicted data 323 for each group.

Specifically, for each actual measurement value indicated in the actual measurement divided data 322, the comparison unit 124 selects a predicted value corresponding to the actual measurement value from the predicted data 323. Then, for each actual measurement value indicated in the actual measurement divided data 322, the comparison unit 124 compares the actual measurement value with the selected predicted value.

Then, the comparison unit 124 generates comparison result data 324 for each group.

The comparison result data 324 indicates results of comparison between the actual measurement divided data 322 and the predicted data 323. That is, the comparison result data 324 indicates a result of comparison for each actual measurement value indicated in the actual measurement divided data 322. A specific result of comparison is a difference between the actual measurement value and the predicted value.

In step S125, the integration unit 125 integrates the comparison result data 324 of the individual groups. As a result, the integration unit 125 generates integrated result data 325.

The integrated result data 325 includes all pieces of the comparison result data 324.

In step S126, the detection unit 126 detects the state of the facility 210 based on the integrated result data 325.

Specifically, the detection unit 126 calculates the sum of differences indicated in the integrated result data 325, and determines the state of the facility 210 based on the calculated sum. If the calculated sum is less than or equal to a threshold, the detection unit 126 determines that the state of the facility 210 is the normal state. If the calculated sum is greater than the threshold, the detection unit 126 determines that the state of the facility 210 is the anomalous state.

Then, the detection unit 126 generates facility state data 326.

The facility state data 326 indicates the state of the facility 210.

In step S127, the output unit 127 outputs the facility state data 326.

For example, if the facility state data 326 indicates the anomalous state, the output unit 127 displays a message indicating the anomalous state of the facility 210 on the display.

### Description of Implementation Example

Division by the division unit 112 and the division unit 122 may be performed in accordance with an instruction from the user. In this case, the division unit 112 displays the collected data 312 on the display. The user operates the input device to designate a division method. Then, the division unit 112 divides the collected data 312 in accordance with the designated division method. The division unit 122 divides the actual measurement data 321 in a similar manner.

### Effects of Embodiment 1

The state detection system 100 divides the production facility to be learned into a plurality of appropriate groups, and applies machine learning to each group.

As a result, it is possible to solve the problem that if the scale of a target production facility increases and the number of signals increases, the relationships between signals become complex, increasing a required learning time and a required amount of learning data.

By dividing the production facility to be learned into a plurality of appropriate groups, the behavior of the target to be learned is simplified compared to a case where learning is performed without dividing the target to be learned. Comprehensive learning data is no longer required, reducing the required learning time and the required amount of learning data.

In addition, by executing a plurality of learned models in parallel, the time required for diagnosis can be expected to be reduced. Furthermore, the number of objective variables handled by one learned model is reduced, so that it becomes easier to concentrate on the objective variables of the target to be learned so as to learn behavior, and prediction accuracy can be expected to be enhanced.

### Description of Variation

The collected data 312 may include anomalous data in chronological order. That is, the normal model 301 of each group may be generated based on the normal data 311 in chronological order and the anomalous data in chronological order.

First, the collection unit 111 collects the normal data 311 in chronological order when the state of the facility 210 is the normal state, and collects anomalous data in chronological order when the state of the facility 210 is the anomalous state. Then, the collection unit 111 accumulates the normal data 311 in chronological order and the anomalous data in chronological order in the collection database 191 as the collected data 312.

Next, the division unit 112 divides a set of signal values (normal values or anomalous values) included in the collected data 312 into a plurality of groups so as to generate collected divided data of each group.

The collected divided data indicates one or more signal values (normal values or anomalous values) in each group in chronological order.

Then, the learning unit 113 performs machine learning for each group, using the collected divided data as learning data, so as to generate the normal model 301 of each group.

At this time, a machine learning method such as one that determines boundaries between normal and anomalous is used.

For example, the learning unit 113 uses an unsupervised learning technique to automatically learn classifications of normal and anomalous. A specific example of the unsupervised learning technique is k-means clustering.

For example, the learning unit 113 uses a supervised learning technique to learn boundaries between normal and anomalous. In this case, a group with an anomaly is specifically specified depending on an anomaly such as jamming of a workpiece. A specific example of the supervised learning technique is a support vector machine.

### Embodiment 2

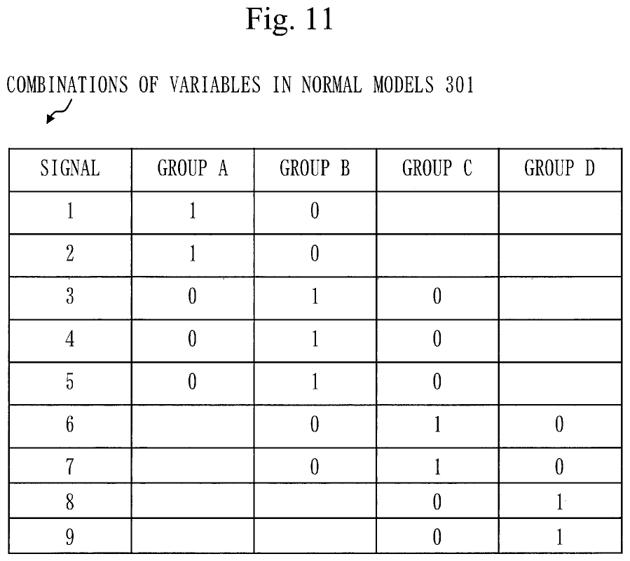

With regard to parameters of the normal model 301, differences from Embodiment 1 will be mainly described based on FIG. 11.

### Description of Configuration

The configuration of the facility system 200 is the same as the configuration in Embodiment 1.

The configuration of the state detection system 100 is the same as the configuration in Embodiment 1.

A configuration of the parameters of the normal model 301 will be described.

A group corresponding to each normal model 301 will be referred to as a target group. A group immediately prior to the target group will be referred to as a preceding group, and a group immediately after the target group will be referred to as a subsequent group.

The normal model 301 has one or more explanatory variables for the target group, one or more explanatory variables for the preceding group, and one or more explanatory variables for the subsequent group. The normal model 301 also has one or more objective variables for the target group.

FIG. 11 illustrates an example of combinations of variables in the normal models 301. “0” signifies an explanatory variable. “1” signifies an objective variable and an explanatory variable.

It is assumed that there are four groups in the order of a group A, a group B, a group C, and a group D.

The normal model 301 for the group A has two explanatory variables (and objective variables) for the group A and three explanatory variables for the group B.

In the two explanatory variables for the group A, signal values of two signals (1, 2) belonging to the group A are set.

In the three explanatory variables for the group B, signal values of three signals (3 to 5) belonging to the group B are set.

The normal model 301 for the group B has two explanatory variables for the group A, three explanatory variables (and objective variables) for the group B, and two explanatory variables for the group C.

In the two explanatory variables for the group C, signal values of two signals (6, 7) belonging to the group C are set.

The normal model 301 for the group C has three explanatory variables for the group B, two explanatory variables (and objective variables) for the group C, and two explanatory variables for the group D.

In the two explanatory variables for the group D, signal values of two signals (8, 9) belonging to the group D are set.

The normal model 301 for the group D has two explanatory variables for the group C and two explanatory variables (and objective variables) for the group D.

### Description of Operation

The procedure for the state detection method is the same as the procedure in Embodiment 1.

However, how the normal model 301 is generated in step S113 is different from how it is generated in Embodiment 1.

In addition, how the normal model 301 is used in step S123 is different from how it is used in Embodiment 1.

In step S113, the learning unit 113 performs machine learning for each group, using the normal divided data 313 as learning data.

At this time, the learning unit 113 uses the normal divided data 313 of the target group, the normal divided data 313 of the preceding group, and the normal divided data 313 of the subsequent group as the learning data.

Specifically, the learning unit 113 sets one or more normal values of the target group in one or more explanatory variables for the target group. The learning unit 113 sets one or more normal values of the preceding group in one or more explanatory variables for the preceding group. The learning unit 113 sets one or more normal values of the subsequent group in one or more explanatory variables for the subsequent group. Then, the learning unit 113 performs machine learning. As a result, the normal model 301 of the target group is generated.

In step S123, the prediction unit 123 generates the predicted data 323 for each group, using the normal model 301.

At this time, the prediction unit 123 uses, as input data, the actual measurement divided data 322 of the target group at the preceding time, the actual measurement divided data 322 of the preceding group at the preceding time, and the actual measurement divided data 322 of the subsequent group at the preceding time.

Specifically, the prediction unit 123 sets one or more actual measurement values of the target group at the preceding time in one or more explanatory variables for the target group. The prediction unit 123 also sets one or more actual measurement values of the preceding group at the preceding time in one or more explanatory variables for the preceding group. The prediction unit 123 also sets one or more actual measurement values of the subsequent group at the preceding time in one or more explanatory variable for the subsequent group. Then, the prediction unit 123 calculates the normal model 301 of the target group. As a result, one or more predicted values for the target group are calculated. The one or more calculated predicted values are set in the one or more objective variables for the target group. The prediction unit 123 acquires the one or more predicted values for the target group from the one or more objective variables for the target group.

### Effects of Embodiment 2

In Embodiment 2, explanatory variables for signals of the preceding and subsequent groups are added to the target to be learned.

In a production facility, workpieces are transported from the preceding group to the target group. Therefore, in order to predict the behavior of a signal of the target group, it is preferable to add a signal of the preceding group as an explanatory variable. If the subsequent group is not empty, the target group cannot send out a workpiece. Therefore, in order to predict the behavior of a signal of the target group, it is preferable to add a signal of the subsequent group as an explanatory variable.

Embodiment 2 enables more accurate learning and more accurate prediction. As a result, more accurate state detection is possible.

### Embodiment 3

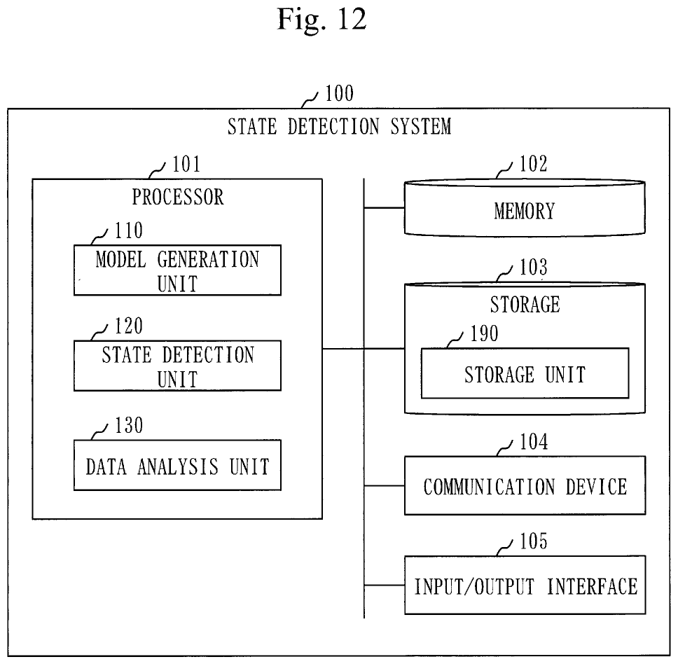

With regard to an embodiment in which the group information data 199 is generated, differences from Embodiments 1 and 2 will be mainly described based on FIGS. 12 to 15.

### Description of Configuration

Based on FIG. 12, the configuration of the state detection system 100 will be described.

The state detection system 100 further includes a data analysis unit 130.

The state detection program further causes a computer to function as the data analysis unit 130.

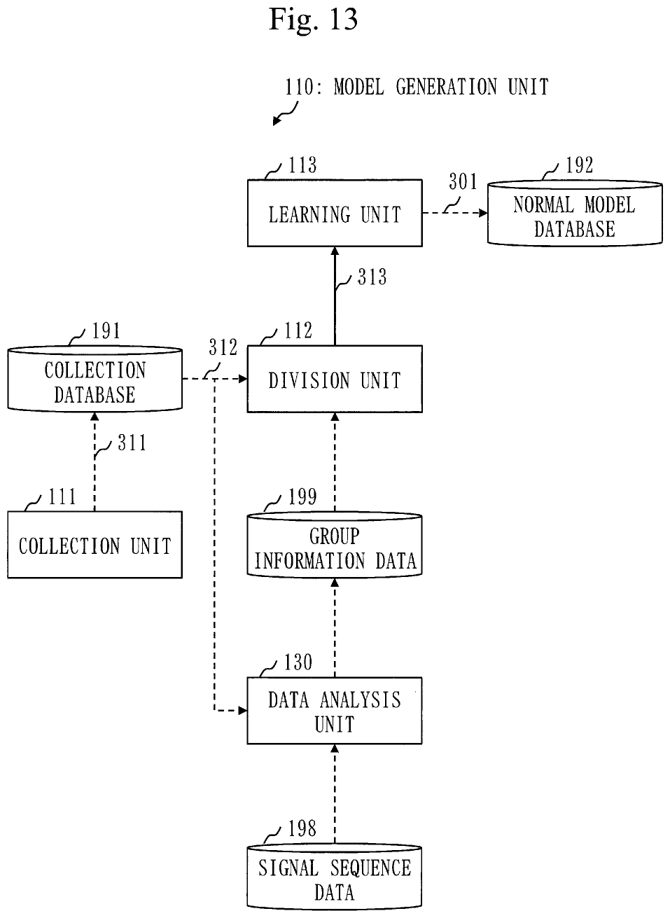

FIG. 13 illustrates functional relationships of the model generation unit 110 and the data analysis unit 130.

Signal sequence data 198 indicates a reaction sequence of a plurality of signals in the facility 210. The signal sequence data 198 is stored in the storage unit 190 in advance. For example, the signal sequence data 198 is generated by the user.

### Description of Operation

In the state detection method, the procedure for the model generation process (S110) is different from the procedure in Embodiment 1.

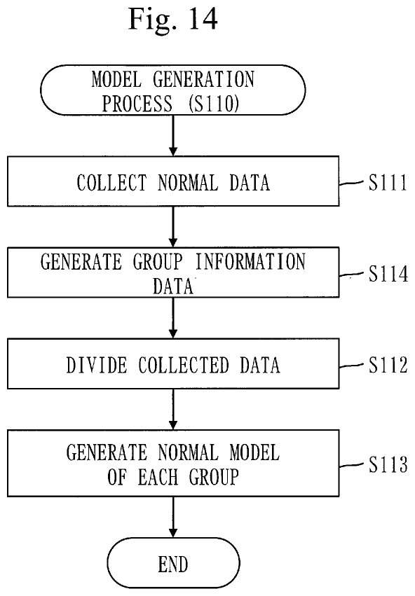

Based on FIG. 14, the procedure for the model generation process (S110) will be described. It is characterized by step S114.

Step S114 is executed after step S111 and before step S112.

In step S114, the data analysis unit 130 analyzes the collected data 312 to determine one or more signals belonging to each group.

Next, the data analysis unit 130 generates data that indicates the one or more signals belonging to each group. The generated data is the group information data 199.

Then, the data analysis unit 130 stores the group information data 199 in the storage unit 190.

At this time, the data analysis unit 130 may analyze the entirety of the collected data 312, or may analyze a portion of the collected data 312 (for example, data of 30 minutes).

The one or more signals belonging to each group are determined as described below. In the following procedure, the data analysis unit 130 determines the reaction sequence of the plurality of signals in the facility 210 by referring to the signal sequence data 198.

First, the data analysis unit 130 determines a signal that reacts first in the facility 210 (base signal) as the first signal in the first group.

Next, the data analysis unit 130 determines, as each signal belonging to the first group, zero or one or more signals that react in sequence during a period from a reaction of the first signal in the first group to the next reaction of the first signal in the first group.

Further, the data analysis unit 130 determines, as the first signal of each group of the second and subsequent groups, a signal that reacts next after the last signal in the immediately preceding group.

Then, the data analysis unit 130 determines, as each signal belonging to each group of the second and subsequent groups, one or more signals that react in sequence during a period from a reaction of the first signal in each group of the second and subsequent groups to the next reaction of the first signal in each group of the second and subsequent groups.

During a period from a reaction of the first signal in each group to the next reaction of the first signal in each group, only one workpiece exists in each group. That is, a plurality of workpieces do not exist concurrently in each group.

If sections in which a plurality of workpieces do not exist concurrently vary by time of day, the data analysis unit 130 may perform grouping based on the collected data 312 of a time period in which each section is narrow. That is, if a plurality of groups that are determined vary by time of day, the data analysis unit 130 may select a plurality of groups with a small number of signals belonging to each group.

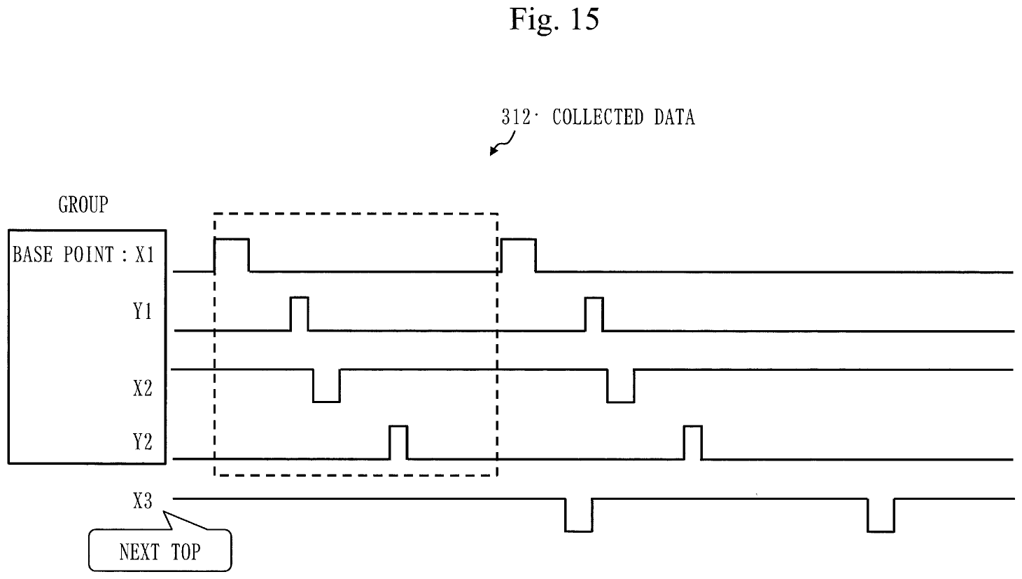

Based on FIG. 15, an example of grouping of signals will be described.

A signal X1 is the base signal. Each signal reacts in the sequence of the signal X1, a signal Y1, a signal X2, a signal Y2, and a signal X3.

During a period from a reaction of the signal X1 to the next reaction of the signal X1, the signal Y1, the signal X2, and the signal Y2 react in sequence. On the other hand, the signal X3 does not react during the period from a reaction of the signal X1 to the next reaction of the signal X1.

Therefore, the signal X1, the signal Y1, the signal X2, and the signal Y2 belong to the first group. The signal X3 is the first signal of the second group.

### Effects of Embodiment 3

In Embodiment 3, a production facility is divided into sections in each of which a plurality of workpieces do not exist concurrently.

The state detection system 100 analyzes operation data of the production facility to perform division. At this time, a prerequisite is that the reaction sequence of signals is clear. A section in which a plurality of workpieces do not exist concurrently is treated as one group. The state detection system 100 divides a plurality of signals in the production facility according to the reaction sequence.

Embodiment 3 eliminates the need for manual grouping, so that effort of the user can be reduced.

### Embodiment 4

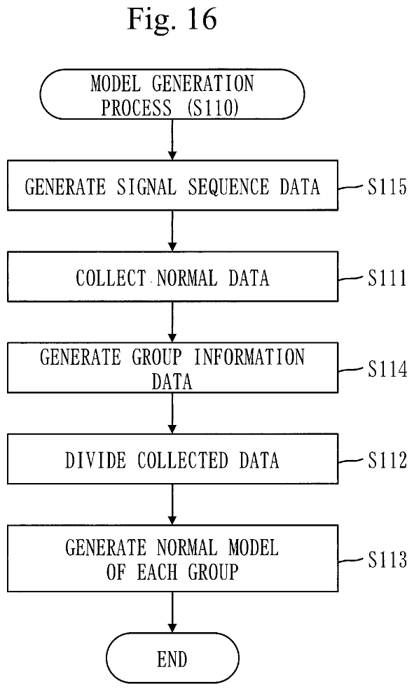

With regard to an embodiment in which the signal sequence data 198 is generated, differences from Embodiment 3 will be mainly described based on FIG. 16.

### Description of Configuration

The configuration of the state detection system 100 is the same as the configuration in Embodiment 3.

### Description of Operation

In the state detection method, the procedure for the model generation process (S110) is different from the procedure in Embodiment 3.

Based on FIG. 16, the procedure for the model generation process (S110) will be described. It is characterized by step S115.

Step S115 is executed before step S111.

In step S115, the user causes only one workpiece to be moved in a flow in the facility 210.

First, the data analysis unit 130 collects operation data at each time point while only one workpiece is moved in a flow in the facility 210. Specifically, the data analysis unit 130 receives the operation data at each time point from the control device 220.

Next, the data analysis unit 130 analyzes the operation data at each time point to identify a sequence of signals whose signal values have changed. The identified sequence is the reaction sequence of a plurality of signals.

Next, the data analysis unit 130 generates data that indicates the reaction sequence of the plurality of signals. The generated data is the signal sequence data 198.

Then, the data analysis unit 130 stores the signal sequence data 198 in the storage unit 190.

### Effects of Embodiment 4

In Embodiment 4, the reaction sequence of a plurality of signals is analyzed.

The state detection system 100 infers a sequence in which the plurality of signals react by analyzing log data (operation data at each time point) of a case where only one workpiece is moved in a flow in a production facility. Then, the state detection system 100 uses the reaction sequence of the signals for automatic division.

Embodiment 4 eliminates the need to manually input the reaction sequence of signals, so that effort of the user can be reduced.

### Embodiment 5

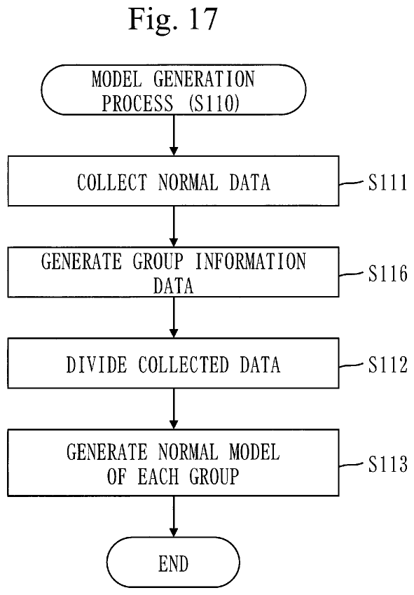

With regard to an embodiment in which groups are integrated if there are many groups, differences from Embodiment 3 will be mainly described based on FIG. 17.

### Description of Configuration

The configuration of the state detection system 100 is the same as the configuration in Embodiment 3.

### Description of Operation

In the state detection method, the procedure for the model generation process (S110) is different from the procedure in Embodiment 3.

Based on FIG. 17, the procedure for the model generation process (S110) will be described. It is characterized by step S116.

Step S116 corresponds to step S114 in Embodiment 3.

In step S116, the data analysis unit 130 performs grouping of one or more signals belonging to each group, as in step S114 of Embodiment 3.

Next, the data analysis unit 130 determines whether groups are to be integrated based on the number of groups. If the number of groups is greater than a threshold (for example, 10 groups), the data analysis unit 130 determines that groups are to be integrated.

If it is determined that groups are to be integrated, the data analysis unit 130 integrates groups in accordance with an integration rule.

For example, the data analysis unit 130 integrates two or more consecutive groups into one group so that the number of groups to be integrated is uniform. If the number of groups is 40 and the threshold is 10 groups, the data analysis unit 130 integrates every four groups starting from the first group. As a result, the number of groups becomes 10.

For example, the data analysis unit 130 integrates two or more consecutive groups into one group so that the number of signals belonging to each group after integration is uniform.

Next, the data analysis unit 130 generates data that indicates one or more signals belonging to each group after integration. The generated data is the group information data 199.

Then, the data analysis unit 130 stores the group information data 199 in the storage unit 190.

If it is determined that groups are not to be integrated, the data analysis unit 130 generates data that indicates one or more signals belonging to each group without integrating groups. The generated data is the group information data 199.

Then, the data analysis unit 130 stores the group information data 199 in the storage unit 190.

### Effects of Embodiment 5

In Embodiment 5, groups are integrated if there are many groups.

If there are many groups (for example, 40 groups) as a result of automatic division, it is difficult to operate all the learned models concurrently. In such a case, the state detection system 100 integrate groups (for example, into 10 groups) and applies machine learning.

Embodiment 5 allows the number of learned models to be operated concurrently to be adjusted.

### Supplement to Embodiment 5

Embodiment 5 may be implemented in combination with Embodiment 4. That is, the data analysis unit 130 may generate the signal sequence data 198.

### Embodiment 6

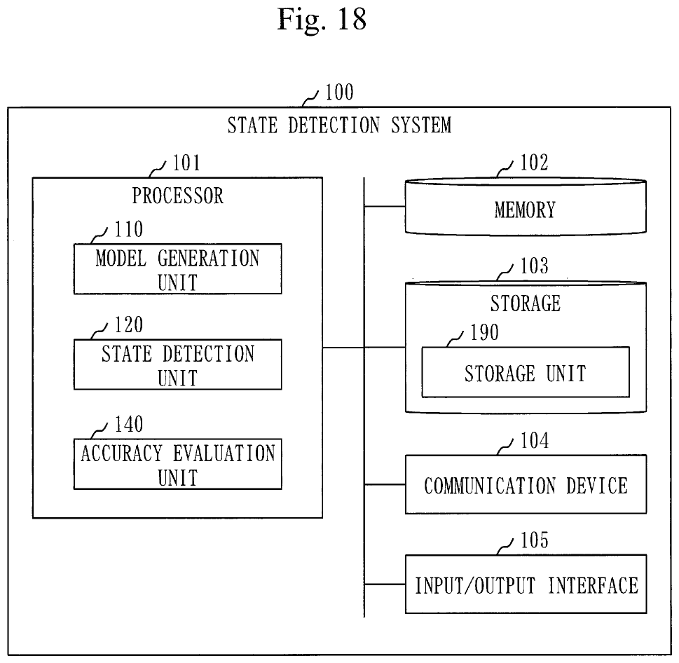

With regard to an embodiment in which the accuracy of prediction by the normal model 301 is enhanced, differences from Embodiment 1 will be mainly described based on FIGS. 18 to 20.

### Description of Configuration

Based on FIG. 18, the configuration of the state detection system 100 will be described.

The state detection system 100 further includes an accuracy evaluation unit 140.

The state detection program further causes a computer to function as the accuracy evaluation unit 140.

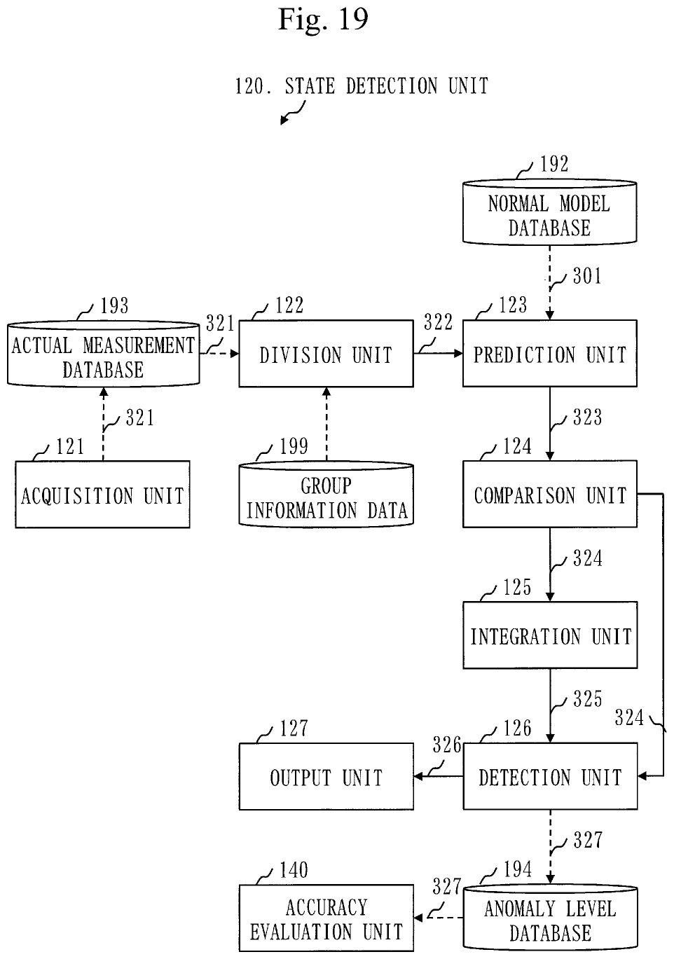

FIG. 19 illustrates functional relationships of the state detection unit 120 and the accuracy evaluation unit 140.

An anomaly level database 194 is stored in the storage unit 190.

### Description of Operation

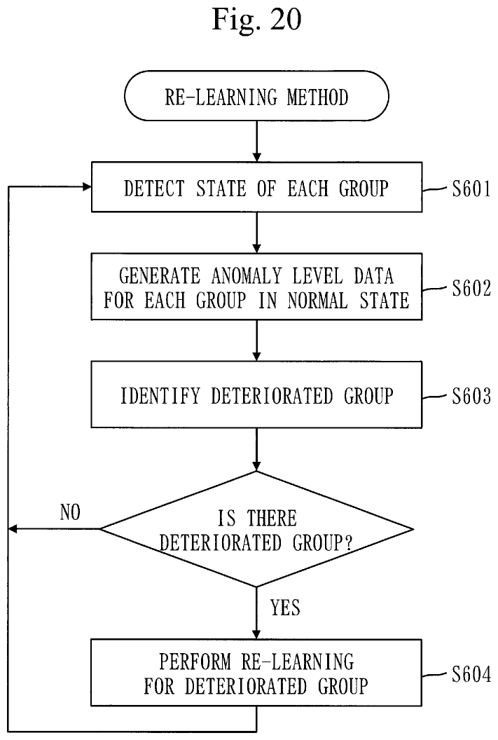

Based on FIG. 20, a re-learning method will be described. The re-learning method is a part of the state detection method.

Step S601 to step S604 are executed at each time point.

In step S601, the detection unit 126 detects the state of each group based on the comparison result data 324 of each group.

For example, the detection unit 126 calculates the sum of differences indicated in the comparison result data 324, and determines the state of the group based on the calculated sum. If the calculated sum is less than or equal to a threshold, the detection unit 126 determines that the state of the group is the normal state. If the calculated sum is greater than the threshold, the detection unit 126 determines that the state of the group is the anomalous state.

In step S602, the detection unit 126 selects the comparison result data 324 of each group in the normal state.

Next, the detection unit 126 calculates an anomaly level for each group in the normal state based on the comparison result data 324. For example, the detection unit 126 calculates, as the anomaly level, the sum of differences indicated in the comparison result data 324. The anomaly level represents an error of one or more predicted values with respect to one or more actual measurement values.

Next, the detection unit 126 generates data that indicates the anomaly level for each group in the normal state. The generated data is anomaly level data 327.

Then, the detection unit 126 stores the anomaly level data 327 of each group in the normal state in the anomaly level database 194.

In step S603, the accuracy evaluation unit 140 acquires the anomaly level data 327 of each group from the anomaly level database 194.

Then, the accuracy evaluation unit 140 identifies a deteriorated group based on the anomaly level data 327 of each group.

The deteriorated group is a group corresponding to the normal model 301 whose accuracy is inferred to have deteriorated.

Specifically, the accuracy evaluation unit 140 identifies a group whose anomaly level has deteriorated as the deteriorated group.

For example, if the anomaly level is greater than a threshold, the accuracy evaluation unit 140 determines that the anomaly level has deteriorated. An example of the threshold is 1.5 times a criterion value. The criterion value is a value defined as a criterion for the anomaly level in the normal state.

For example, the accuracy evaluation unit 140 calculates an average of anomaly levels in one or more pieces of the anomaly level data 327 accumulated over a certain period (for example, one day). If the calculated average is greater than a threshold, the accuracy evaluation unit 140 determines that the anomaly level has deteriorated.

For example, the accuracy evaluation unit 140 determines a trend in anomaly levels in one or more pieces of the anomaly level data 327 accumulated over a certain period of time (for example, one week). The trend in anomaly levels is expressed by the slope of a regression line, for example. If the trend in anomaly levels is a rising trend of a certain degree or more, the accuracy evaluation unit 140 determines that the anomaly level has deteriorated.

If there is an identified group, processing proceeds to step S604.

If there is no identified group, processing proceeds step S601.

In step S604, the model generation unit 110 performs machine learning for the deteriorated group. That is, the model generation unit 110 performs re-learning for the deteriorated group.

Specifically, the model generation unit 110 performs machine learning using, as learning data, the normal divided data 313 of the deteriorated group obtained after the preceding machine learning for the deteriorated group has been performed.

As a result, the normal model 301 of the deteriorated group is updated.

The procedure for step S604 is the same as the procedure in the model generation process (S110).

For re-learning, the collection unit 111 may accumulate the actual measurement data 321 of a case where the state of the facility 210 is determined to be the normal state in the collection database 191 as the normal data 311.

### Effects of Embodiment 6

In Embodiment 6, re-learning is performed for each group.

In a production facility, it is often the case that only specific areas are modified. Therefore, the state detection system 100 evaluates the learned model for each group to automatically check its accuracy on a regular basis. Then, if the accuracy of a specific group has deteriorated, the state detection system 100 automatically performs re-learning only for the specific group.

Embodiment 6 enables re-learning in a shorter time in comparison with a case where re-learning is performed for the entire facility.

### Supplement to Embodiment 6

Re-learning may be performed using collected divided data as learning data, as in the variation of Embodiment 1.

Embodiment 6 may be implemented in combination with at least one of Embodiments 2 to 5.

### Description of Variation

A deteriorated group may be identified manually.

The user evaluates a false-positive rate or a false-negative rate for each group so as to identify a deteriorated group. Then, the user operates the input device to designate the deteriorated group to the state detection system 100.

The model generation unit 110 accepts the designation of the deteriorated group, and performs re-learning for the designated deteriorated group.

### Supplement to Embodiments

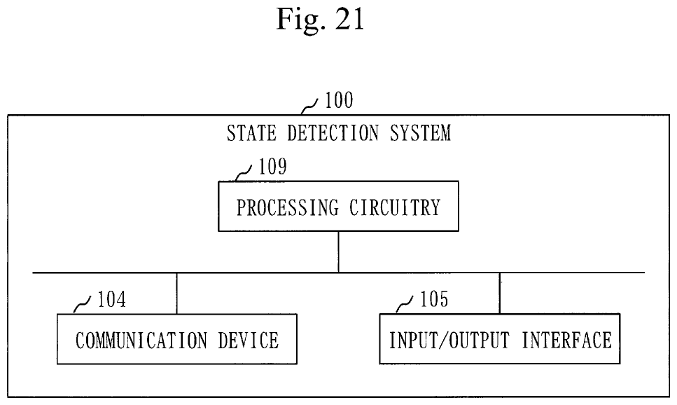

Based on FIG. 21, a hardware configuration of the state detection system 100 will be described.

The state detection system 100 includes processing circuitry 109.

The processing circuitry 109 is hardware that realizes the model generation unit 110, the state detection unit 120, the data analysis unit 130, and the accuracy evaluation unit 140.

The processing circuitry 109 may be dedicated hardware, or may be the processing circuitry 109 that executes programs stored in the memory 102.

When the processing circuitry 109 is dedicated hardware, the processing circuitry 109 is, for example, a single circuit, a composite circuit, a programmed processor, a parallel-programmed processor, an ASIC, an FPGA, or a combination of these.

ASIC is an abbreviation for application specific integrated circuit.

FPGA is an abbreviation for field programmable gate array.

The state detection system 100 may include a plurality of processing circuits as an alternative to the processing circuitry 109.

In the processing circuitry 109, some functions may be realized by dedicated hardware and the remaining functions may be realized by software or firmware.

As described above, the functions of the state detection system 100 can be realized by hardware, software, firmware, or a combination of these.

Each of the embodiments is an example of a preferred embodiment, and is not intended to limit the technical scope of the present disclosure. Each of the embodiments may be partially implemented, or may be implemented in combination with another embodiment. The procedures described using flowcharts or the like may be suitably changed.

Each “unit” that is an element of the state detection system 100 may be interpreted as “process”, “step”, “circuit”, or “circuitry”.

### REFERENCE SIGNS LIST

100: state detection system, 101: processor, 102: memory, 103: storage, 104: communication device, 105: input/output interface, 109: processing circuitry, 110: model generation unit, 111: collection unit, 112: division unit, 113: learning unit, 120: state detection unit, 121: acquisition unit, 122: division unit, 123: prediction unit, 124: comparison unit, 125: integration unit, 126: detection unit, 127: output unit, 130: data analysis unit, 140: accuracy evaluation unit, 190: storage unit, 191: collection database, 192: normal model database, 193: actual measurement database, 194: anomaly level database, 198: signal sequence data, 199: group information data, 200: facility system, 201: network, 202: network, 210: facility, 220: control device, 230: target device, 231: sensor, 232: actuator, 240: production facility, 241: workpiece, 301: normal model, 311: normal data, 312: collected data, 313: normal divided data, 321: actual measurement data, 322: actual measurement divided data, 323: predicted data, 324: comparison result data, 325: integrated result data, 326: facility state data, 327: anomaly level data.

1. A state detection system to detect a state of a facility in which a workpiece is moved in a flow, the state detection system comprising
processing circuitry to:
collect, in chronological order, collected data that indicates a plurality of signal values of a plurality of signals that react in sequence according to the flow of the workpiece,
divide a set of the plurality of signal values included in the collected data in chronological order into a plurality of signal groups that depend on a position of the workpiece, so as to generate, for each group, collected divided data that indicates one or more signal values in each group in chronological order,
perform machine learning for each group, using the collected divided data as learning data, so as to generate a normal model, which is a learned model, for each group, and
detect a state of the facility, using the normal model of each group.

2. The state detection system according to claim 1,
wherein the normal model of a target group in the plurality of signal groups has one or more explanatory variables for the target group, one or more explanatory variables for a preceding group, and one or more explanatory variables for a subsequent group, the preceding group being a group immediately prior to the target group, the subsequent group being a group immediately after the target group, and
wherein the processing circuitry generates the normal model of the target group by performing machine learning by setting the one or more signal values of each of the target group, the preceding group, and the subsequent group in the one or more explanatory variables for each corresponding group.

3. The state detection system according to claim 1,
wherein the processing circuitry divides the set of the plurality of signal values into the plurality of signal groups, based on group information data that indicates, on a per group basis, the plurality of signals divided into the plurality of signal groups according to a reaction sequence.

4. The state detection system according to claim 3,
wherein the processing circuitry analyzes the collected data in chronological order to determine one or more signals belonging to each of the plurality of groups, and generates data that indicates the one or more signals belonging to each of the plurality of groups as the group information data,
determines a signal that reacts first in the facility as a first signal in a first group, and determines zero or one or more signals that react in sequence during a period from a reaction of the first signal in the first group to a next reaction of the first signal in the first group as a signal or signals belonging to the first group,
determines a signal that reacts next after a last signal in an immediately preceding group as a first signal in each of second and subsequent groups, and
determines one or more signals that react in sequence during a period from a reaction of the first signal in each of the second and subsequent groups to a next reaction of the first signal in each of the second and subsequent groups as a signal or signals belonging to each of the second and subsequent groups.

5. The state detection system according to claim 4,
wherein the processing circuitry collects operation data that indicates a plurality of signal values at each time point during a period in which only a single one of the workpiece is moved in a flow in the facility,
analyzes the operation data at each time point to identify a sequence of signals whose signal values have changed as the reaction sequence,
generates data that indicates the reaction sequence of the plurality of signals as signal sequence data, and
determines the reaction sequence of the plurality of signals by referring to the signal sequence data when each signal belonging to each of the plurality of groups is determined.

6. The state detection system according to claim 4,
wherein after one or more signals belonging to each of the plurality of groups are determined, the processing circuitry determines whether groups are to be integrated based on the number of groups, and
when it is determined that groups are not to be integrated, generates data that indicates the one or more signals belonging to each of the plurality of groups as the group information data without integrating groups, and
when it is determined that groups are to be integrated, integrates groups in accordance with an integration rule, and generates data that indicates one or more signals belonging to each group after integration as the group information data.

7. The state detection system according to claim 1,
wherein the processing circuitry acquires actual measurement data that indicates a plurality of signal values of the plurality of signals as a plurality of actual measurement values,
divides the plurality of actual measurement values in the actual measurement data into the plurality of signal groups, so as to generate actual measurement divided data for each group, the actual measurement divided data indicating one or more actual measurement values in each group,
generates predicted data for each group, using the normal model of each group, the predicted data indicating one or more signal values predicted in each group as one or more predicted values,
compares the actual measurement divided data with the predicted data for each group to generate comparison result data for each group,
integrates the comparison result data of individual groups to generate integrated result data, and
detects a state of the facility based on the integrated result data.

8. The state detection system according to claim 7,
wherein the normal model of a target group in the plurality of signal groups has one or more explanatory variables for the target group, one or more explanatory variables for a preceding group, and one or more explanatory variables for a subsequent group, the preceding group being a group immediately prior to the target group, the subsequent group being a group immediately after the target group, and
wherein the processing circuitry generates the normal model of the target group by performing the machine learning by setting the one or more signal values of each of the target group, the preceding group, and the subsequent group in the one or more explanatory variables for each corresponding group, and
calculates the one or more predicted values of the target group by calculating the normal model of the target group by setting the one or more actual measurement values at a preceding time of each of the target group, the preceding group, and the subsequent group in the one or more explanatory variables for each corresponding group.

9. The state detection system according to claim 7,
wherein the processing circuitry divides the set of the plurality of signal values into the plurality of signal groups, based on group information data that indicates, on a per group basis, the plurality of signals divided into the plurality of signal groups according to a reaction sequence, and
divides the plurality of actual measurement values into the plurality of signal groups, based on the group information data.

10. The state detection system according to claim 9,
wherein the processing circuitry analyzes the collected data in chronological order to determine each signal belonging to each of the plurality of groups, and generates data that indicates each signal belonging to each of the plurality of groups as the group information data,
determines a signal that reacts first in the facility as a first signal in a first group, and determines zero or one or more signals that react in sequence during a period from a reaction of the first signal in the first group to a next reaction of the first signal in the first group as a signal or signals belonging to the first group,
determines a signal that reacts next after a last signal in an immediately preceding group as a first signal in each of second and subsequent groups, and
determines one or more signals that react in sequence during a period from a reaction of the first signal in each of the second and subsequent groups to a next reaction of the first signal in each of the second and subsequent groups as a signal or signals belonging to each of the second and subsequent groups.

11. The state detection system according to claim 10,
wherein the processing circuitry collects operation data that indicates a plurality of signal values at each time point during a period during which only a single one of the workpiece is moved in a flow in the facility,
analyzes the operation data at each time point to identify a sequence of signals whose signal values have changed as the reaction sequence of the plurality of signals,
generates data that indicates the reaction sequence of the plurality of signals as signal sequence data, and
determines the reaction sequence of the plurality of signals by referring to the signal sequence data when each signal belonging to each of the plurality of groups is determined.

12. The state detection system according to claim 10,
wherein after each signal belonging to each of the plurality of groups is determined, the processing circuitry determines whether groups are to be integrated based on the number of groups, and
when it is determined that groups are not to be integrated, generates data that indicates each signal belonging to each of the plurality of groups as the group information data without integrating groups, and
when it is determined that groups are to be integrated, integrates groups in accordance with an integration rule, and generates data that indicates each signal belonging to each group after integration as the group information data.

13. The state detection system according to claim 7,
wherein the processing circuitry detects a state of each group based on the comparison result data of each group, calculates an anomaly level of the one or more predicted values for each group in a normal state based on the comparison result data, and generates anomaly level data that indicates the anomaly level for each group in the normal state,
identifies, as a deteriorated group, a group corresponding to the normal model whose accuracy is inferred to have deteriorated, based on the anomaly level data of each group, and
performs the machine learning for the deteriorated group to update the normal model of the deteriorated group.

14. The state detection system according to claim 1,
wherein the processing circuitry accepts designation of a deteriorated group corresponding to the normal model whose accuracy is inferred to have deteriorated, and performs the machine learning for the deteriorated group to update the normal model of the deteriorated group.

15. A state detection method for detecting a state of a facility in which a workpiece is moved in a flow, the state detection method comprising:
collecting, in chronological order, collected data that indicates a plurality of signal values of a plurality of signals that react in sequence according to the flow of the workpiece;
dividing a set of the plurality of signal values included in the collected data in chronological order into a plurality of signal groups that depend on a position of the workpiece, so as to generate, for each group, collected divided data that indicates one or more signal values in each group in chronological order;
performing machine learning for each group, using the collected divided data as learning data, so as to generate a normal model, which is a learned model, for each group; and
detecting a state of the facility, using the normal model of each group.

16. A non-transitory computer readable medium storing a state detection program to detect a state of a facility in which a workpiece is moved in a flow, the state detection program causing a computer to execute:
a collection process of collecting, in chronological order, collected data that indicates a plurality of signal values of a plurality of signals that react in sequence according to the flow of the workpiece;
a division process of dividing a set of the plurality of signal values included in the collected data in chronological order into a plurality of signal groups that depend on a position of the workpiece, so as to generate, for each group, collected divided data that indicates one or more signal values in each group in chronological order;
a learning process of performing machine learning for each group, using the collected divided data as learning data, so as to generate a normal model, which is a learned model, for each group; and
a state detection process of detecting a state of the facility, using the normal model of each group.
